(19) United States
(12) Patent Application Publication
(10) Pub. No.: US 2007/0102388 A1
(43) Pub. Date: May 10, 2007

(54) Vented, low-drip nursing nipple

(76) Inventors: Julie Maureen Lewis, Portland, OR (US); Daniel J. Bedell, Beaverton, OR (US)

Correspondence Address: SMITH-HILL AND BEDELL, P.C., 16100 NW CORNELL ROAD, SUITE 220, BEAVERTON, OR, 97006, US

(21) Appl. No.: 11/262,016

(22) Filed: Oct. 28, 2005

(51) Int. Cl. A61J 11/00; A61J 9/00

(52) U.S. Cl. 215/11.1

(57) ABSTRACT

A nipple assembly for a nursing bottle includes a nipple having a slit at the bottom of a concave depression in its tip acting as a fluid outlet valve. The nipple includes a flange seated on the rim of the bottle and held in place by a cap having a central opening through which the nipple extends. A threaded ring on the cap engages the threaded bottle neck with the outer circumferential edge of the nipple's flange compressed between the annular top and the rim of the bottle. The nipple flange includes vent apertures between its inner and outer circumferential edges, and a raised annular bead between its inner circumferential edge and the aperture. The annular bead provides a seal between flange and the cap that prevents fluid from leaking out the vent apertures when air pressure within the bottle is not substantially lower than ambient air pressure. When the air pressure inside the bottle falls below ambient air pressure as the infant suck fluid from the bottle, the annular bead moves away from the cap to break the seal, thereby permitting air to pass through the central opening and into the bottle via the vent apertures. The nipple includes one or more raised annular beads to provide tactile stimulation to a nursing infant and to improve the seal between the infant's lips and the nipple body to limit fluid leakage.

### BACKGROUND OF THE INVENTION

1. Field of the Invention

The present invention relates in general to nursing bottles and in particular to a nipple for a nursing bottle that vents the bottle when an infant is nursing and prevents drips when the infant is not nursing.

2. Description of Related Art

Although a need for nursing bottles may have arisen on Earth not long after the appearance of mammals, there is scant evidence in the archaeological record of attempts to fulfill that need prior to Roman times. Ceramic pitchers with nipple-like spouts have been found in ancient tombs of Roman babies. To feed an infant using this device would have required some dexterity and concentration, as it is necessary to insert the nipple into infant's mouth and tilt the pitcher when infant wanted to nurse and then quickly return it to upright when infant wanted to stop nursing. Any miscalculation as to the timing of the infant's intention to stop nursing, or an unexpected kick from infant, could result in a major spill. The infant may not have been completely happy with the device either, finding a cold, hard ceramic nipple a poor substitute for the real thing.

Despite the deficiencies of the Roman nursing bottle, there was little improvement to the basic design until the invention of the rubber nipple in the mid 19th century, one of the earliest and arguably most greatly appreciated applications of rubber. Examples of flexible nipples made of natural or synthetic rubber, plastic and other materials for nursing bottles are described in the following patents:

U.S. Pat. No. 22,579 issued Jan. 11, 1859 to Potter,

U.S. Pat. No. 26,327 issued Nov. 29, 1859 to La Forme,

U.S. Pat. No. 467,176 issued Jan. 19, 1892 to Jensen,

U.S. Pat. No. 605,161 issued Jun. 7, 1989 to Clement et al,

U.S. Pat. No. 586,011 issued Jul. 6, 1897 to Butz,

U.S. Pat. No. 589,212 issued Aug. 31, 1897 to Michael,

U.S. Pat. No. 785,707 issued Aug. 11, 1903 to Cantwell,

U.S. Pat. No. 1,099,082 issued Jun. 2, 1914 to Decker,

U.S. Pat. No. 5,035,340 issued Jul. 30, 1991 to Timmons,

U.S. Pat. No. 6,161,710 issued Dec. 19, 2000 to Dieringer, and

U.S. Pat. No. 6,250,487 issued Jun. 26, 2001 to Tebeau.

With the liquid fully enclosed except for a small slit or hole in the tip of the nipple sized to provide sufficient flow to the infant, it was no longer necessary for mother or nanny to be quite so attentive or skillful to avoid major spills.

A nursing bottle having an opening only in the nipple tip does have a drawback. As the infant draws liquid out of the bottle though the nipple, air in the bottle must expand to fill the void let by the departing liquid, thereby lowering the air pressure in the bottle. As the air pressure in the bottle continues to decline, the infant must suck harder on the bottle to remove additional liquid, until at some point the partial vacuum in the bottle has grown so strong the infant is no longer able to draw any more liquid out of the bottle. Although the infant need only stop nursing and calmly allow the bottle to draw additional air back into the bottle through the hole in the nipple tip, thereby relieving the partial vacuum, not all hungry babies have the foresight to do that. Some prefer to continue desperately sucking without success until, red-faced and frustrated, they give up and cry.

Sympathetic inventors have resolved this problem by providing a vent to permit air to enter the bottle to replace the departing liquid while the infant is nursing The following U.S. patents teach the use of a one-way valve in the bottom of the nursing bottle to vent the bottle as the infant nurses:

U.S. Pat. No. 362,554 issued May 10, 1887 to Suydam,

U.S. Pat. No. 1,037,309 issued Sep. 3, 1912 to Poore,

U.S. Pat. No. 2,084,099 issued Jun. 15, 1937 to Maccoy,

U.S. Pat. No. 3,768,683 issued Oct. 30, 1973 to Van Den Bosch,

U.S. Pat. No. 4,685,577 issued Aug. 11, 1987 to Chen,

U.S. Pat. No. 4,828,126 issued May 9, 1989 to Vincinguerra, and

U.S. Pat. No. 5,607,074 issued Mar. 4, 1997 to De Gennaro.

A bottle having a bottom valve is difficult and expensive to manufacture, and the valves may have small parts that are difficult to clean. The following U.S. patents describe a nursing bottle employing a disposable, collapsible bag in lieu of a rigid bottle for holding the liquid:

U.S. Pat. No. 3,718,140 issued Feb. 27, 1973 to Yamauchi,

U.S. Pat. No. 3,822,806 issued Jul. 9, 1974 to Grimes, and

U.S. Pat. No. 4,339,046 issued Jul. 13, 1982 to Coen.

Since the bag collapses as the infant nurses, there is no need to vent it. A less expensive approach is to provide one or more vents in areas of the nipple remaining outside the infant's mouth, as the infant nurses. The following U.S. patents teach variations on that approach:

U.S. Pat. No. 1,146,639 issued Jul. 13, 1915 to Miller,

U.S. Pat. No. 2,174,361 issued May 16, 1936 to Condon,

U.S. Pat. No. 2,616,581 issued Nov. 4, 1953 to Madsen et al,

U.S. Pat. No. 2,753,067 issued Jul. 3, 1956 to Rodrigues,

U.S. Pat. No. 2,942,746, issued May 31, 1957 to Porthouse et al,

U.S. Pat. No. 2,960,088 issued Nov. 15, 1960 to Witz,

U.S. Pat. No. 2,996,207 issued Aug. 15, 1961 to Witz,

U.S. Pat. No. 3,113,569 issued Dec. 10, 1963 to Barr et al,

U.S. Pat. No. 3,492,139 issued Feb. 18, 1970 to Faddoul et al,

U.S. Pat. No. 5,474,028 issued Dec. 12, 1995 to Larson et al,

U.S. Pat. No. 5,797,505 issued Aug. 25, 1998 to Kaura, and

U.S. Pat. No. 5,881,893 issued Mar. 16, 1999 to Manganiello.

When an infant is not nursing, liquid can leak out of a nursing bottle through the hole in the nipple tip. When the infant holds the bottle in his or her mouth without nursing, as for example when the infant falls asleep without releasing the nipple, continual leakage of milk or other liquid into the infant's mouth can cause tooth decay and other problems. Such leakage is particularly troublesome when the hole in the nipple tip is made relatively large to accommodate a flow rate sufficient for larger babies. One approach to reducing such leakage is provide an aperture in the nipple tip that opens to permit increased liquid flow when a infant is nursing and then substantially closes when the infant is not nursing to reduce the amount of leakage. One way to do that is to form a slit in an area of the nipple tip that is very thin and flexible. When the infant depresses the nipple and draws liquid through the slit, the slit opens to permit liquid flow, but when the infant stops nursing, the slit closes to reduce leakage. The following U.S. patents disclose this idea:

U.S. Pat. No. 2,688,326 issued Sep. 7, 1954 to Lerman, and

U.S. Pat. No. 3,718,140 issued Feb. 27, 1973 to Yamauchi.

This type of nipple tip can substantially reduce the amount of liquid that drips out of the tip of a non-vented bottle when an infant is not nursing since flow out of the tip is opposed by a residual partial vacuum in the bottle that tends to keep the slit closed. However since a vented bottle does not allow a partial vacuum to form within the bottle, leakage can occur though through even a relatively small slit. Liquid can also drip through a vented bottle's air vent when the vent does not provide a tight seal when the infant is not nursing.

U.S. Patent Publication No. 2004/0188373, based on a patent application filed Sep. 30, 2004 by Lewis et al, describes a nipple including a slitted nipple tip and an air vent in its nipple flange that seals when the air pressure inside the bottle is not substantially less than the air pressure outside the bottle to prevent leakage through the air vent when the infant is not nursing. Although the slit will close to prevent leakage through the slit when the air pressure inside and outside the bottle are equalized, leakage can occur through the slitted nipple tip if the bottle is flexible and the infant squeezes the bottle, thereby increasing the air pressure in the bottle and forcing the liquid through the slit.

### BRIEF SUMMARY OF THE INVENTION

A nipple assembly for a nursing bottle in accordance with the invention includes a nipple having a slit at the bottom of a concave depression in its tip acting as a fluid outlet valve. The slit opens when a nursing infant deforms the nipple by squeezing it with its mouth and closes when the infant releases the nipple to prevent leakage. When the bottle is made of flexible material, the concave shape of the nipple tip tends to close the slit more tightly to prevent liquid from squirting out the slit when the infant increases pressure inside the bottle by squeezing it when not nursing.

The nipple includes a flange seated on the rim of the bottle and held in place by a cap having a central opening through which the nipple extends. A threaded ring on the cap engages the threaded bottle neck with the outer circumferential edge of the nipple's flange compressed between the annular top and the rim of the bottle. The nipple flange includes vent apertures between its inner and outer circumferential edges, and a raised annular bead between its inner circumferential edge and the aperture. The annular bead provides a seal between flange and the cap that prevents fluid from leaking out the vent apertures when air pressure within the bottle is not substantially lower than ambient air pressure. When the air pressure inside the bottle falls below ambient air pressure, the annular bead moves away from the cap to break the seal, thereby permitting air to pass through the central opening and into the bottle via the vent apertures.

The nipple includes one or more raised annular beads circumscribing its outer surface to provide tactile stimulation to a nursing infant and to improve the seal between the infant's lips and the nipple to limit fluid leakage

### BRIEF DESCRIPTION OF THE DRAWINGS

FIG. 1 is an elevation view of a nipple in accordance with the invention.

FIG. 2 is an elevation view of the nipple of FIG. 1 installed on a bottle.

FIG. 3 is a sectional elevation view of the nipple of FIG. 1.

FIG. 4 is a sectional elevation views of the nipple of FIG. 1 installed on a bottle when air pressure outside the bottle is not substantially larger than air pressure inside the bottle.

FIG. 5 is sectional elevation views of the nipple of FIG. 1 installed on a bottle when air pressure outside the bottle is substantially larger than air pressure inside the bottle.

FIG. 6 is a plan view of the nipple of FIG. 1.

### DETAILED DESCRIPTION OF THE INVENTION

The present invention relates to a nursing bottle having an air inlet aperture and a liquid outlet aperture that opens when an infant is nursing and closes to reduce leakage when the infant stops nursing. The nursing bottle also includes an air inlet valve that opens to vent the bottle when the infant is nursing and then closes when the infant stops nursing to inhibit liquid leakage. While the specification describes at least one exemplary embodiment of the invention considered to be a best mode of practicing the invention, the invention is not limited to the exemplary embodiment(s) described below or to the manner in which the exemplary embodiments operate.

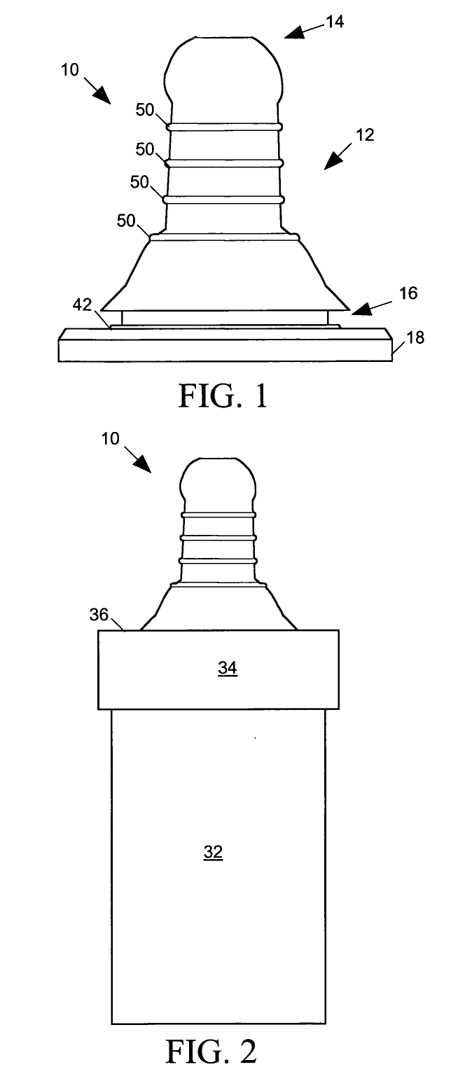

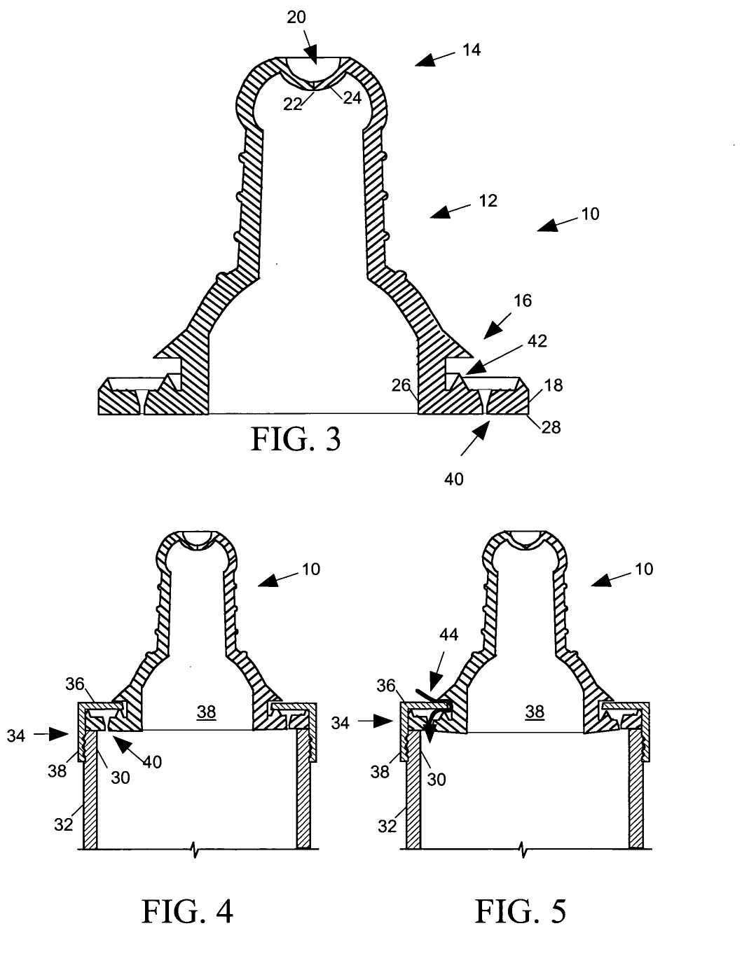

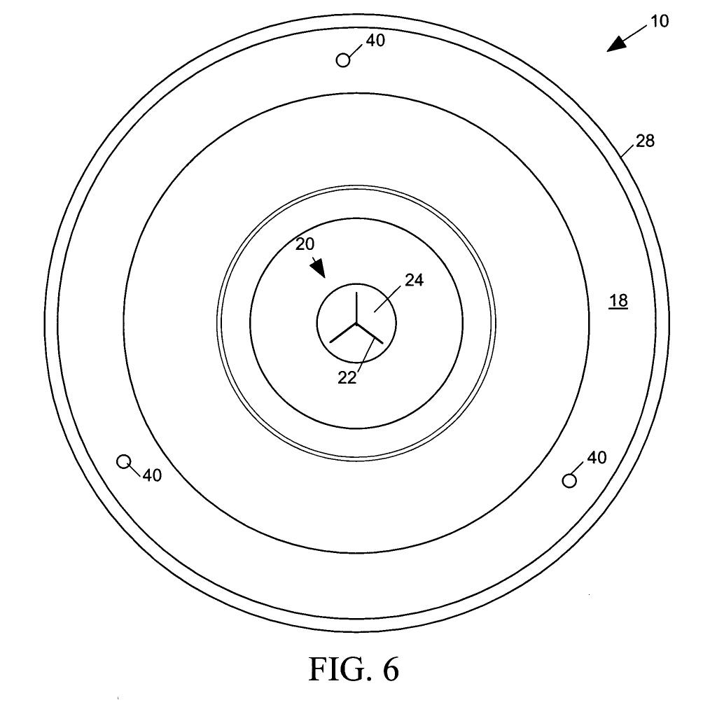

Referring to FIGS. 1-6, nipple 10, formed of resilient, flexible material such as natural or synthetic rubber or plastic, includes a hollow nipple body 12 having a distal end 14, a proximal end 16 and an annular flange 18 attached to the proximal end of the nipple body. The distal end 14 of nipple body 12 includes a concave depression 20 extending downward toward its proximal end 16. An outlet aperture formed by a small, thin slit 22 or hole at the bottom of depression 20 acts as a liquid outlet valve that opens when an infant deforms nipple body 12 while nursing, thereby allowing the infant to draw liquid through slit 22. When the infant stops nursing on nipple body 12, and stops deforming it, slit 22 closes to prevent liquid leakage. Slit 22 self-regulates flow rate based on how hard the infant sucks on nipple body 12, and the length of slit 22 influences liquid flow rate. Slit 22 is suitably made relatively short for small babies demanding relatively low flow rates and relatively long for larger babies demanding relatively high flow rates. The flexible material in an area 24 surrounding slit 22 is preferably of reduced thickness in relation to that of other areas of the nipple body 12 to allow it more flexibility so that it opens wider when the infant sucks harder. Slit 22 is preferably Y-shaped as shown in FIG. 6, but may be other shapes.

Annular nipple flange 18 includes an inner circumferential edge 26 joined to the proximal end 16 of nipple body 12 and an outer circumferential edge 28 for engaging the rim 30 of a bottle 32. A retainer cap 34 includes an annular top 36 with a central opening 38 through which nipple body 12 extends. Retainer cap 34 also includes a threaded annular ring 38 for engaging threaded bottle rim 30 to compress the outer circumferential edge 28 of nipple flange 18 between cap top 36 and bottle neck rim 30, thereby providing a tight seal between nipple 10 and bottle rim 30.

Apertures 40 in flange 18 between its inner and outer circumferential edges 26 and 28 provide passages for air to enter bottle 32 when a nursing infant reduces the air pressure within the bottle below ambient air pressure outside the bottle by drawing liquid from the bottle via slit 22. Nipple flange 18 includes an annular bead 42 between its annular inner edge 26 and apertures 40. When cap 34 is mounted on bottle rim 30 compressing outer circumferential edge 28 between cap top 36 and bottle rim 30, the under side of cap top 36 presses down on bead 42, deflecting flange 18 downward. Since flange 18 is made of resilient material, its deformation causes it to apply an upward force on annular bead 42 opposing the downward force applied by cap top 36. The opposing forces hold annular bead 42 tightly against the under side of cap top 36 as illustrated in FIG. 4, forming a seal between annular bead 42 and cap top 36 preventing air or liquid from passing through apertures 40 and between cap top 36 and nipple body 12.

When a nursing infant removes liquid from bottle 32 though slit 22, the air pressure inside the bottle falls below ambient air pressure, creating a partial vacuum in the bottle that pulls nipple flange 18 downward, thereby breaking the seal between annular bead 42 and cap top 36 as illustrated in FIG. 5. With the seal broken, vent air 44 passes through a gap between cap top 36 and nipple body 12, though the space between annular bead 42 and cap top 36, through apertures 40 and into bottle 32 to relieve the partial vacuum in bottle 32.

When the infant stops nursing, vent air 44 continues to flow into bottle 32 until the air pressure inside bottle 12 becomes sufficiently high relative to ambient air pressure to allow the upward force provided by deformed flange 18 to again push bead 42 into contact with cap top 36 to cut off further air flow into the bottle.

The liquid outlet valve formed by slit 22 in depression 20 and the air inlet valve formed by bead 42 and cap top 34 work thus together to regulate liquid flow out of bottle 32 and to prevent excessive loss of air pressure inside the bottle when the infant is nursing, and to substantially reduce or eliminate liquid leakage when the infant is not nursing. Slit 22 opens to permit liquid flow when the nursing infant sucks on and squeezes the nipple, and closes to substantially prevent liquid leakage when the infant stops nursing on the nipple. The air inlet valve formed by flange bead 18 and cap top 34 opens to allow vent air 44 to enter bottle 12 through apertures 40 when the infant nurses, but closes tightly under substantial pressure from deflected flange 18 to cut off the flow of vent air after the infant stops nursing.

Bottle 32 may be formed of a flexible material such as plastic, and when the infant is not nursing but is squeezing the bottle, the air pressure inside the bottle can rise above the ambient air pressure. The high air pressure in the bottle forces nipple body 12 upward to provide a tighter seal between annular bead 43 and cap top 36 to prevent liquid from escaping the bottle through inlet vent apertures 40. The increased air pressure in bottle 32 also tends to push on depression 20 in a manner that causes slit 22 to close more tightly, thereby preventing liquid from escaping through the slit. When an infant squeezes a bottle having a conventional nipple of the type having a convex tip, the increasing air pressure in the bottle tends to open the slit in the tip, rather than close it, allowing the liquid to spray out Thus the combination of a slit in a concave depression at the distal end of the nipple acting as an outlet value, and the self-closing inlet valve mechanism of nipple 10 of the present invention allows an infant to easily draw liquid from the bottle when nursing and yet prevents liquid loss when the infant is not nursing, even when the infant squeezes the bottle.

Nipple body 12 includes a set of raised annular beads 50 circumscribing its outer surface provide a pleasing tactile simulation to the nursing infant. The beads 50 also help to provide a seal between the nipple body 12 and the infant's lips when nursing thereby reducing liquid seepage between the nipple body and the infant's lips.

Thus has been shown and described a nursing bottle nipple having a slitted, concave tip and an air inlet valve that open when infant nurses to allow liquid to flow out of the bottle and to allow air to flow into the bottle, and which close when the infant stops nursing to prevent liquid leakage even when the infant squeezes the bottle. The annular beads 50 surrounding nipple body 12 also help to reduce liquid spillage and provide the infant with pleasing tactile stimulation while nursing.

The foregoing specification and the drawings depict exemplary embodiments of the best mode(s) of practicing the invention, and elements or steps of the depicted best modes exemplify the elements or steps of the invention as recited in the appended claims. However the appended claims are intended to apply to any mode of practicing the invention comprising the combination of elements or steps as described in any one of the claims, including elements or steps that are functional equivalents of the example elements or steps of the exemplary embodiment(s) of the invention depicted in the specification and drawings.

1. An apparatus for covering an annular rim of a bottle containing liquid for an infant, the apparatus comprising:
a resilient, hollow nipple body including a proximal end and a distal end, and
a flexible annular nipple flange having an inner circumferential edge joined to the proximal end of the nipple body, an outer circumferential edge for engaging the bottle rim, an inlet aperture between its inner and outer circumferential edge, and a raised first annular bead between its annular inner edge and the inlet aperture,
wherein the nipple body includes a concave depression at its distal end, the depression having an outlet aperture at a point nearest the distal end of the nipple body that opens to provide an outlet for the liquid when the infant nurses on the nipple body, and that closes to prevent liquid from leaving the bottle when the infant refrains from nursing and air pressure within the bottle is higher than air pressure outside the bottle.

2. The apparatus in accordance with claim 1 further comprising:
a retainer cap having an annular top with a central opening through which the proximal end of the nipple body extends, and having a threaded annular ring for engaging the rim of the bottle to compress the outer circumferential edge of the nipple flange between the annular top of the cap and the rim, thereby providing a tight seal between the nipple flange and the rim,
wherein when air pressure within the bottle is higher than air pressure external to the bottle, the retainer cap's annular top engages the nipple flange's annular bead deforming the nipple flange so that it applies a substantial force pressing its first annular bead against the annular top, the first annular bead and the annular top thereby providing a seal impeding air and liquid flow through the inlet aperture and the central opening in the retainer cap's annular top, and
wherein when the air pressure within the bottle is substantially lower than air pressure external to the bottle, the first annular bead disengages from the annular top of the retainer cap breaking the seal, thereby permitting air to pass into the bottle via the central opening of retainer cap and the inlet aperture.

3. The apparatus in accordance with claim 1
wherein the nipple body has an outer surface including at least one raised second annular bead for providing tactile simulation to the nursing infant and for providing a seal between the nipple body and lips of the infant when nursing on the nipple body.

4. The apparatus in accordance with claim 1
wherein the nipple body has an outer surface including a plurality of raised annular beads for providing tactile simulation to the infant when nursing on the nipple body and for providing a seal between the nipple body and lips of the nursing infant.

5. The apparatus in accordance with claim 1 wherein a thickness of material forming the nipple body surrounding the outlet aperture is substantially less than a thickness of material forming other areas of the nipple body.

6. The apparatus in accordance with claim 1 wherein the outlet aperture is an elongate slit in the nipple body.

7. The apparatus in accordance with claim 1 wherein the outlet aperture is a hole in the nipple body.

8. The apparatus in accordance with claim 2
wherein the nipple body has an outer surface including at least one raised second annular bead for providing tactile simulation to the nursing infant and for providing a seal between the nipple body and lips of the nursing infant.

9. The apparatus in accordance with claim 2
wherein the nipple body has an outer surface including a plurality of raised annular beads for providing tactile simulation to the infant when nursing on the nipple body and for providing a seal between the nipple body and lips of the nursing infant.

10. The apparatus in accordance with claim 2 wherein a thickness of material forming the nipple body surrounding the outlet aperture is substantially less than a thickness of material forming other areas of the nipple body.

11. The apparatus in accordance with claim 2 wherein the outlet aperture is formed by an elongate slit in the flexible material.

12. The apparatus in accordance with claim 3 wherein a portion of the flexible material surrounding the outlet aperture is of substantially reduced thickness in relation to the flexible material forming other areas of the nipple body.

13. The apparatus in accordance with claim 3 wherein the outlet aperture is formed by an elongate slit in the depression.

14. An apparatus for covering an annular rim of a bottle containing liquid for an infant, the apparatus comprising:
a resilient, hollow nipple body including a proximal end and a distal end, the nipple body having an outer surface including at least one raised second annular bead for providing tactile simulation to the nursing infant and for providing a seal between the nipple body and lips of the nursing infant, and
a flexible annular nipple flange having an inner circumferential edge joined to the proximal end of the nipple body, an outer circumferential edge for engaging the bottle rim.

15. The apparatus in accordance with claim 14
wherein the outer surface of the nipple body includes a plurality of raised annular beads.

16. The apparatus in accordance with claim 14
wherein the at least one raise annular beads circumscribes the outer surface of the nipple body.
